(19) United States
(12) Patent Application Publication
(10) Pub. No.: US 2006/0041906 A1
(43) Pub. Date: Feb. 23, 2006

(54) Electronic service information application appropriate for display on devices having smaller display screens

(75) Inventor: Larri Vermola, Turku (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/920,737

(22) Filed: Aug. 17, 2004

(51) Int. Cl. H04N 5/445

(52) U.S. Cl. 725/39

(57) ABSTRACT

A service information computer program application and devices and systems that implement the same that is formatted so as to be adaptable to portable digital devices, typically handheld device that have small displays. The service information application provides service program schedules in a hierarchical format, as such, the user benefits from a guide that is highly user-friendly in the small display environment. The application is able to readily locate and access program schedules, program options and program information through minimal user-interface with the application. Additionally, the service information application may provide a record function and ease in locating programs that have been stored by the digital device.

### FIELD OF THE INVENTION

The present invention relates to electronic service guides and, more specifically, to methods, systems, devices and computer program applications for providing the display of an electronic service guide on a digital device having a limited viewable display area, such as a handheld digital device.

### BACKGROUND OF THE INVENTION

Electronic Service Guides (ESG) are graphical user interface (GUI) applications that provide users with a navigation system for program schedules related to communication media, such as television, radio or the like. The ESG provides for the digital display of future scheduling and programming details for the related communication media. In one of the most common applications, the ESG is implemented by cable television or satellite television service providers to offer subscribers television-display of program scheduling and programming details. Typically, in the television application, the ESG computer program resides at the set-top cable box or at the satellite receiver and either the service provider or the broadcasting networks provide data, in the form of program schedules and program details, to the ESG by means of satellite or cable communication.

Handheld digital devices, such as cellular telephones, personal data assistants (PDAs), portable audio and/or video devices and the like, are becoming increasingly sophisticated in the level of services that they provide. In the near future, users can envision cellular telephones, PDAs and other handheld devices equipped with the means to receive and display television signals or and other broadcast media communications. These multi-purpose digital devices will likely not be limited to receiving local television signals. Rather, these devices may benefit from receiving other wireless communication signals, such as satellite signals, wireless cable television signals or any other type of video-over-wireless-network communication.

Most handheld digital devices that are equipped with displays, such as cellular telephones, PDAs and the like, are limited by the size of the display and the user interfaces that allow for user to interact with displayed information. Conventional, non-portable, television set displays offer significantly larger displays than portable devices and the larger displays can accommodate the display of large amounts of graphical text. As such, the existing ESG applications are written to adapt to these large displays. In the handheld device the display size prohibits the use of conventional ESG applications because the display size provides for display of only a portion of the text or the display downsizes the text to the degree in which it is no longer readable to the device user. While the problem of text display can be mitigated by ample user scrolling of the contents of the ESG, such practice does not lend itself to a comprehensive user friendly experience.

FIG. 1 provides an example of the problems encountered with executing a conventional ESG application, generally formatted for a large display, on a portable handheld digital device. The digital device 10 includes a small display 20 and a user interface, such as in the illustrated embodiment a joystick 30 or arrow keys 40. The ESG application provides an ESG view 50 that presents programming details in a grid-like format. The program channels listings 60 are presented in the vertical plane and time slots listings 70 are presented in the horizontal plane. Program details 80 are mapped to the corresponding program channel and time slot. In order for a user to find information pertaining to a particular channel or a particular time slot, excessive use of the joystick, keypad or other user-interface will typically be required to access the information. In addition, since the application is not formatted for the small display, a user who attempts to access program information may have difficulty correlating the information to the appropriate channel and time slot. In addition, since the cells in the grid are not formatted for the small display, the user will typically have to scroll or otherwise reposition the view in order to read the text contained in a cell. Thus the conventional ESG application, when implemented on a digital device having a small display, is not conducive to a friendly user experience.

Additionally, portable digital devices may possess the functionality to digitally record and store programming, such as television programming, radio programming or the like. The storage unit may be embodied within the portable digital device or the storage may be remote from the portable device, such that the portable device wirelessly communicates with a storage server to access. The user of the portable digital device will benefit from an application that allows for easily locating programs that have been recorded and providing ease in activating the stored programs.

Therefore the need exists to develop an ESG application that is conducive to handheld devices or any other device having a relatively small display size. The desired application should provide program schedules and program details/highlights to the user in a highly user-friendly environment. As such, the desired application will provide program schedules and program details in a format that allows for users of small displayed devices to readily read the information/text without having to overly manipulate user-interfaces, such as scrolling functions or the like. Also, the desired application will provide the user with a means of storing programs and easily locating and activating programs that have been stored by the device. In addition, the desired ESG application will be simplistic in design to allow the user to interact with the display of information without requiring ample instruction or familiarity with the application.

### BRIEF SUMMARY OF THE INVENTION

The present invention provides for an Electronic Service Guide (ESG) graphical user interface (GUI) application, also commonly referred to as an Electronic Program Guide (EPG), an Interactive Program Guide (IPG), a channel listing, a service listing or the like. For the sake of unity, we refer to the application herein as a service information application. The GUI application is formatted so as to be adaptable to portable digital devices, typically handheld device that have small displays. The service information application of the present invention provides service information, such as program schedules, in a hierarchical format, as such, the user benefits from an application that is highly user-friendly in the small display environment. The user is able to readily locate and access service information, such as program schedules, program options and program information through minimal user-interface with the device. Additionally, the present invention provides for an application that provides recording of services and ease in locating services that have been stored by the digital device.

In one embodiment of the invention an application is provided for accessing service information on a display of a digital device, typically a handheld device having a small area display. The application includes a computer readable storage medium having computer-readable program instructions embodied in the medium. The computer-readable program instructions include first instructions for generating a current service information view that provides access to service information, such as channel and program information, currently being delivered and second instructions for generating future service information views that provide access to service information, such as channel and program information, of future service deliveries. Each of the future service information views are defined by hierarchical time planes. A user of the application implements digital device user-interfaces to change from display of the current service information to one of a chosen future service information views. The user interface may be implemented in the form of horizontally scrolling or left or right arrow key activation to change from display of the current service information to one of a chosen future service information views

In one embodiment the first instructions for generating a current service information view further provides for the current service information view to include a vertically scrollable listing of program title and, typically, corresponding channel.

The second instructions for generating future service information views may further provide for the future service information views to be defined by hierarchical time planes chosen from the group consisting of next time period, next hour, current day, current week, current month and current year. The future service information views may present a vertically scrollable listing of program title and, typically, corresponding channel or a matrix format listing that is vertically and horizontally scrollable. Additionally, the second instructions for generating future service information views that are defined by hierarchical time planes further provide for generating multiple level views within the hierarchical time planes of the future service information views. The multiple level views allow the application user to readily and efficiently locate the desired future service. Typically, vertically scrolling or up and down arrow key activation is implemented to change levels within a hierarchical time plane. One of the levels of views may include a service option level view that may include options such as, recording the service, reminding the device user of the service delivery, communicating the service to a secondary digital device or providing additional information related to the service.

The application embodiment may additionally include third instructions for generating past service information views that provide access to services that have been stored by the digital device. Each of the past service information views are defined by hierarchical time planes. For example, the hierarchical time planes for the past service information views may include current day, prior day, current week, current month and current year. The third instructions may further provide for generating multiple level views within the hierarchical time planes of the future service information views. Typically, the third instructions will provide for the past service information views to include a vertically scrollable listing of stored program title. Access to a stored service title will typically provide for direct access to the recorded service.

The invention is further embodied in a digital device. The device includes a processing unit, a memory unit in communication with the processing unit that stores a service information application in the form of computer-readable program instructions. The instruction include first instructions for generating a current service information view that provides access to service information, such as channel and program information currently being delivered and second instructions for generating one or more future service information views that provide access to service information, such as channel and program information, of future service deliveries and wherein each of the one or more future service information views are defined by hierarchical time planes. The instructions may additionally include third instructions for generating past service information views that provide access to services that have been stored by the digital device. The instructions of the service information application may provide for the same functionality and options as defined in the service information application embodiment described previously in this section.

The digital device also includes a display that displays the current service information view and the future service information views upon execution of the service information application by the processing unit. Optionally, the digital device may include one or more user-interfaces for controlling a view of the service information application presented on the display. The user interfaces may include keyboard entry keys, joystick, arrow keys, touch screen, a mouse or the like. The user interfaces will be horizontally scrollable to provide access to the service information. The digital device may be defined as a mobile communication device, such as mobile telephone, a Personal Data Assistant (PDA), a portable audio device, such as a radio device, and/or a portable video device, such as a portable television.

The invention is also defined in a method for accessing future service program information on a digital device. The method includes the steps of providing a current service information view on a display of the digital device, activating a user interface to change the view to a future service information view including listing of future services, selecting a future service from the future service information view; and displaying a service option view that provides a user options related to the future service. The digital device for which the method applies may be a mobile communication device, such as a mobile telephone, a Personal Data Assistant (PDA), a portable audio device, such as a radio device or a portable video device, such as a television device.

The step of providing a current service information view on a display of the digital device may further include providing a current service information view that includes a vertically scrollable listing of current service. The step of activating a user interface to change the view to a future service information view may further include horizontally scrolling a user interface to change the view to a future service information view. The step of activating a user interface to change the view to a future service information view including a listing of future services may further provides for activating a user interface to change the view to a future service information view including a vertically scrollable listing of future services or a vertically and horizontally scrollable listing of future services.

The step of displaying a service option view that provides a user options related to the future service may further provides for displaying a service option view that provides options related to the future service including a record option for recording the service, a reminder option for reminding a device user of the selected future service delivery and a send option to communicate the selected future service to a secondary digital device. The method may further include the step of selecting any of the above mentioned options.

The invention is also embodied in a method for accessing stored services on a digital device. The method includes the steps of providing a current service information view on a display of the digital device, activating a user interface to change the view to a past service information view including a listing of stored services, selecting a stored service from the future service information view and accessing the stored service. The digital device to which the method applies may include a mobile communication device, such as a mobile telephone, a Personal Data Assistant (PDA), a portable audio device, such as a radio device and a portable video device, such as a television device.

The invention is also embodied in a graphical user interface (GUI) that provides for access to service information on the display of a digital device. The GUI is generated by computer-readable program instructions stored in a computer readable storage medium. The computer-readable program instructions will include first instructions for generating a first view that includes a future time plane and a plurality of user-selectable media objects, wherein each of the selectable media objects correspond to information related to a future service. Typically, the selectable media objects will be objects that include future program information, such as future program title and corresponding channel and selection of a media object will result in the display of further information related to the program.

The GUI will additionally include second instructions for generating a second view that includes a past time plane and a plurality of the user-selectable media objects, wherein each of selectable media objects correspond to information related to previously stored service. As such, the media objects in the second view may represent information and/or access to previously programming that the user or some other entity has designated for storage (i.e., the program has been recorded). User input to the digital device, such as invoking horizontal or vertical scrolling on the display, directs the user interface to change from the first view to the second view.

Therefore, the present invention provides for a service information computer program, devices and systems that implement the service information application and methods for providing service guide information to portable device users. The service information application of the present invention is formatted so as to be adaptable to portable digital devices, typically handheld device that have small displays. The service information application of the present invention provides service program schedules in a hierarchical format, as such, the user benefits from a guide that is highly user-friendly in the small display environment. In this regard, the user is able to readily locate and access program schedules, program options and program information through minimal user-interface with the device. Additionally, the present invention may provide for a guide that provides recording functionality and ease in locating programs that have been stored by the digital device.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustration of a handheld digital device implementing a conventional Electronic Service Guide (ESG) application, in accordance with the prior art.

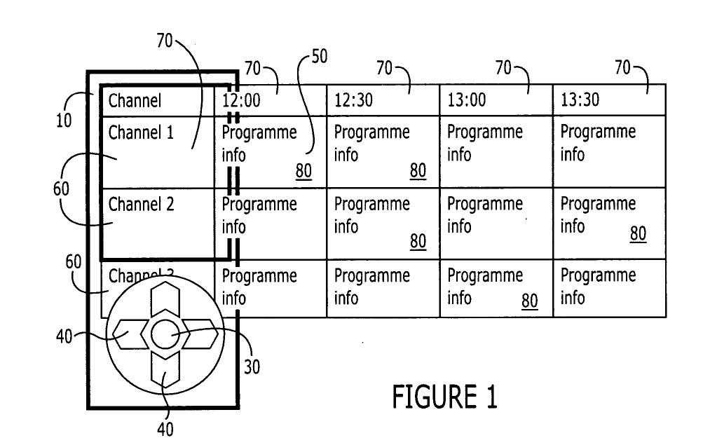

FIG. 2 is a block diagram illustration of a handheld digital device implementing an ESG application formatted for small displays, in accordance with an embodiment of the present invention.

FIG. 3 depicts ESG views of current and future time planes, in accordance with an embodiment of the present invention.

FIG. 4 depicts ESG views of current and past time planes, in accordance with an embodiment of the present invention.

FIG. 5 depicts ESG views of current and future time planes, illustrating the hierarchical aspect of the time planes, in accordance with an embodiment of the present invention.

FIG. 6 depicts ESG views of current and future time planes, further illustrating the hierarchical aspect of the time planes, in accordance with an embodiment of the present invention.

FIG. 7 depicts ESG views of current and future time planes, illustrating view movement from various levels within a time plane, in accordance with an embodiment of the present invention.

FIG. 8 depicts ESG views of current and future time planes, further illustrating view movement from various levels within a time plane, in accordance with an embodiment of the present invention.

FIG. 9 depicts ESG views of current and future time planes, illustrating matrix formatting of the listing within a view to provide for both vertical and horizontal scrolling, in accordance with an embodiment of the present invention.

FIG. 10 depicts ESG views a current date view and an adjacent current date view, illustrating horizontal scrolling from within the matrix format of the view listing, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for an electronic service guide (ESG) graphical user interface (GUI) application, electronic program guide (EPG), interactive program guide, channel listing, service listing, and the like, especially suited for implementation on digital devices having small sized displays. Typically, such a device will be a portable, handheld device equipped with a display. Examples of the portable, handheld device include a mobile telephone, a personal digital assistant (PDA), a display-equipped remote control device, a portable audio and/or video device, such as a portable television, and the like. Therefore, the invention may be defined by a computer program product for an ESG, a digital device that includes and executes the ESG application, a method for displaying service guide information on a portable digital device and a system for providing the ESG-executing digital device programming schedules and program details.

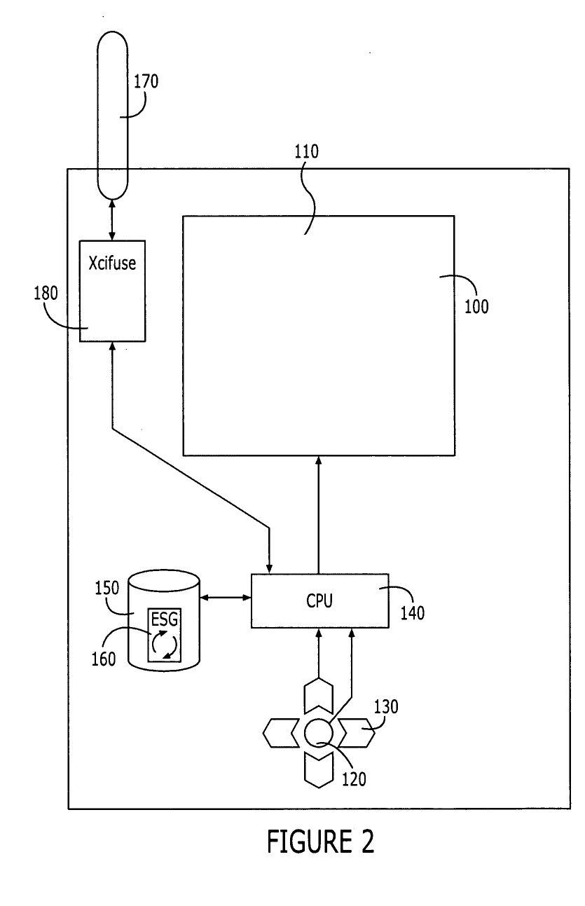

FIG. 2 provides a block diagram of a portable digital device that implements an ESG graphical user interface application, in accordance with an embodiment of the present invention. It should be understood, however, that the portable digital device illustrated and hereinafter described is merely illustrative of one type of device that would benefit from the ESG application of the present invention and, therefore, should not be taken to limit the scope of the present invention. While the embodiment of the digital device illustrated will be hereinafter described for purposes of example, other types of devices, such as portable digital assistants (PDAs), display-equipped remote control devices, audio and/or video device and the like can readily implement the ESG application present invention.

The portable digital device 100 will include a display 110 and one or more user interfaces, such as a joystick 120, arrow keys 130, a keypad (not shown), a keyboard (not shown), a touch screen (nor shown) or the like that allow a user to interface with data presented on the display. Since the device is portable and, typically, handheld in design, the display is generally small in area and therefore is limited in the amount of viewable area. The joystick and/or arrow keys are illustrated by way of example; other means of interfacing with the display are also possible. The display and user-interfaces, being visible to the device user, are configured on the exterior surfaces of the device.

The display and user interfaces are in communication with an internal central processing unit 140. The central processor will typically include both processing and controller functionality. The processing function will be responsible for processing data associated with applications and routines executed by the portable digital device. The central processing unit receives inputs and outputs generated by the functions of the device and controls the functions of the device. As such, the central processing unit receives inputs from user-interfaces, such as the keyboard or display, processes the inputs and generates responses, which may be in the form of signals being sent to the display or to other device components.

The central processing unit will be communication with memory device 150. The memory device stores and provides access to an ESG application 160, otherwise referred to as a graphical user interface. In practice, a user will provide inputs to the user-interfaces requesting access to the ESG, the inputs will trigger signals that are sent to the processing unit. The processing unit responds by accessing the memory unit to execute the ESG application. Execution of the ESG application by the processing unit results in appropriate signals being communicated to the display, which results in the display of ESG images, also referred to herein as ESG views. Additionally, the memory device may store and provide access to content or service that the ESG refers to. Further, the memory device may be an internal or external memory device. For example, the internal memory device may be a hard disc drive (HDD), memory circuit or the like. The external memory may be a memory card or the like.

The portable digital device will typically also include one or more antennas 170 that transmit and/or receive wireless communication signals, broadcasting signals, datacasting signals and the like. In the illustrated embodiment the antenna is in communication with a network transceiver 180. The network transceiver is in communication with the processing unit and is responsible for both transmitting signals to the antenna that have been communicated from the processing unit or receiving signals from the antenna and communicated the signals to the processing unit. In certain embodiments, the network transceiver may be embodied in the processing unit. The network transceiver may be responsible for various network communications, such as cellular network communications, internet communications, broadcast communications (such as radio or television) and the like. In an embodiment in which the network transceiver includes cellular network communication, the transceiver will be configured to communicate signaling information in accordance with the air interface standard of the applicable cellular system, and also user speech and/or user generated data. The transceiver 180 may be a multi carrier signal transceiver or a single carrier transceiver.

The network transceiver will typically provide for the reception of signals related to the service guide and content related to the service guide. For example, if the service guide application provides television program schedules and program details, the network transceiver will receive television signals from an appropriate communication medium. Like wise, if the service guide pertains to radio programs or internet programming, the network transceiver will provide the capability to receive the radio or internet signals. The network transceiver will also typically be responsible for receiving signals that provide program scheduling information and program details to the ESG application. In this regard, the ESG application is able to provide the device user with current information regarding service program scheduling and program details.

In an exemplary embodiment the digital device 100 may include means and devices, not shown in FIG. 2, for receiving and utilizing time-sliced Internet Protocol datacasting (IPDC) transmission, such as Digital Video Broadcasting-Handheld (DVB-H). In such embodiments, the device may include one or more decoders, not shown in FIG. 2, for decoding the IP datacasting stream and one or more buffer memories, not shown in FIG. 2, for storing the decoded IP datacasting stream prior to presenting or utilizing the stream of data.

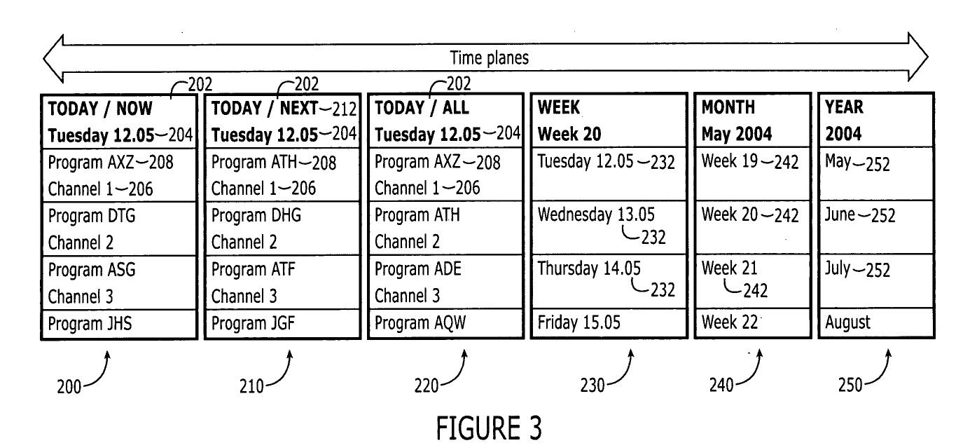

FIGS. 3-10, provide various views of the ESG application or GUI of the present invention as presented on displays of portable digital devices having small display size. In the illustrated embodiment, scrolling in the horizontal direction, activating a left-right arrow key, joy-stick movement or otherwise interfacing with a user-interface provides for incremental changes in the time plane of the view presented to the user. The time planes are hierarchical to each other in future or past time. It is noted that the changes in time planes presented in FIGS. 3-10 are by way of example only. Other time planes can be configured to be presented in the views without departing from the inventive concepts herein disclosed.

FIG. 3 provides for ESG views of time planes that are hierarchical to each other in future time, thus representing future programming, in accordance with an embodiment of the present invention. For example, the current time view 200 will typically be presented to the service guide user upon activation of the service guide. The initial current time view will typically provide a heading portion 202 that for example includes the current date 204. Below the heading portion the view includes a vertical listing of all the program channels 206 and the corresponding program title 208 of the program currently being broadcasted on that channel. It is noted that the channels may be listed in numerical order (as shown), or they may be listed in an order prescribed by service provider preference or digital device user preference. In general, the heading portion in the view may present the date, the time, the title or name of the view, the description, the channel indicator/information and/or the like. Additionally the heading portion of the view may provide for icons, widgets or the like.

In practice, a digital device user will vertically scroll the ESG view in order to display programming information pertaining to a particular channel. By highlighting and/or other wise activating one of the vertical listings, a user can access further information about the program or activation of the listing can result in direct access to the program.

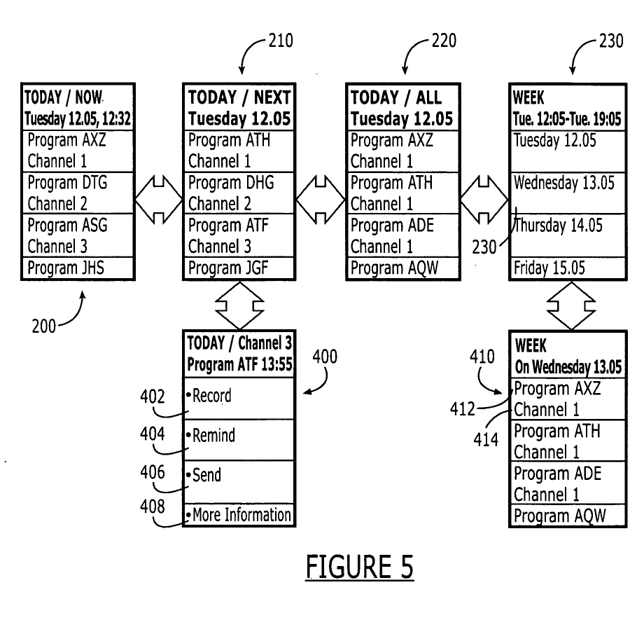

Horizontal scrolling, typically by left or right arrow key activation or right joystick movement, will activate and provide for the display of a different future time plane view. In the illustrated embodiment, right scrolling or key activation from the current time view 200 will result in the display of a next time view 210. The application can be configured such that the next time view is any forthcoming block of time, such as the next 30 minute block, the next 60 minute block or the like. The heading portion 202 may include the current date 204 and the next time period 212. Below the heading portion the next time view includes a vertical listing of all the program channels 206 and the corresponding program title 208 of the program that will be shown in the next time period. By highlighting and/or otherwise activating one of the vertical listings, a user can access further information about the upcoming program or, as shown in FIG. 5, further options for upcoming programs.

Subsequent right scrolling or key activation will result in the next time plane being displayed. In the illustrated embodiment, scrolling or key activation from the next time view 210 will result in the display of a current date view 220. The current date view provides for a vertical listing of all programs scheduled for the current date. The heading portion 202 will include the current date 204. Below the heading portion the current date view includes a vertical listing of all the program titles 208 for a specific channel 206. Continuous vertical scrolling may result in the display of the next channel listings (i.e., Channel 2) for the current date or, more appropriately from a user-friendly perspective, a key stroke activation, such as activation of the down arrow key, double click, or some other key, will result in display of the next channel listing (i.e., Channel 2) for the current date. Highlighting and/or other wise activating one of the vertical listings, a user can access further information about the upcoming program or, as shown in FIG. 5, further options for upcoming programs.

After the display of the current date view 220, subsequent right scrolling or key activation will result in display of the next time plane. In the illustrated embodiment, scrolling or key activation from the current date view 220 will result in the display of the week view 230. The week view provides for a vertical listing of the current week or the next seven day period, with each date 232 representing a listing. Highlighting or activating a date within the listing of the week view will provide for the presentation of the date view for the chosen date. The date view will resemble the current date view 220, in that it will provide for the listing of all channels and all programs broadcast on the channels for the chosen date.

From the week view 230, subsequent right scrolling or key activation will result in the display of the next time plane, such as a month view 240 and/or a year view 250. The month view may be configured to provide for a vertical listing of all the weeks 242 in the current month or the next 30-day period(as shown), all the dates in the current month or the next 30-day period or any other time period related to the month. Highlighting or activating a week within the listing of the month view will provide for the presentation of the week view for the chosen week. The week view will resemble the week view 230, in that it will provide for the listing of all dates of the chosen week. The year view may be configured to provide for a vertical listing of all months 252 in the current year (as shown) or the months in the next 365 day period, the weeks of the current year or the weeks in the next 365 day period, the days of the current year or the days in the next 365 or any other time period related to the year. Highlighting or activating a month within the listing of the year view will provide for the presentation of the month view for the chosen month. The month view will resemble the current month view 240, in that it will provide for the listing of all the weeks or dates for the chosen month. Alternatively, the month and year views may be configured to provide program listings, in lieu of date or time period listings.

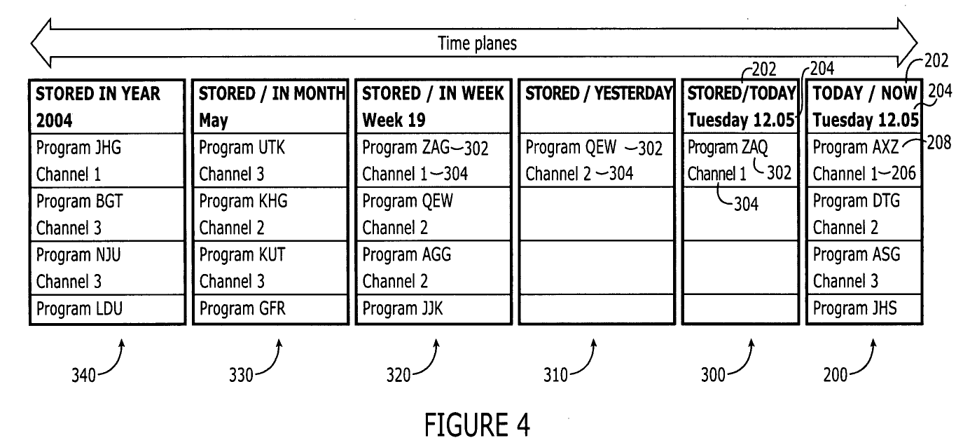

FIG. 4 provides for ESG views of time planes that are hierarchical to each other in past time, thus representing past programming, and in the illustrated example past programming that has been recorded or stored, in accordance with an embodiment of the present invention. Storage of past programming may be internal to the portable digital device or the storage may be external to the portable digital device, such as storage at a service provider server. In the illustrated example, the current time view 200 is shown on the right-hand side and will typically be presented to the service guide user upon activation of the service guide. The current time view 200 is consistent with the current time view shown in FIG. 3.

Scrolling, typically by left or right arrow key activation or left or right movement of a joystick will provide for the display of a different time plane view. In the illustrated embodiment, a left scrolling or key activation from the current time view 200 will result in the display of a stored today view 300. The heading portion 202 will include for example the current date 204. Below the heading portion the stored today view includes a vertical listing of all the stored programs 302, and the corresponding channel 304 of the stored programs that have been stored (i.e., recorded) during the current date. By highlighting and/or other wise activating one of the vertical listings, a user can access further information about the stored program or can directly activate the stored program.

The stored programming may be arranged in a vertical listing according to the time at which they were originally shown or stored, alphabetically, or in numeric order according to channel name, by program topic, or by any other characteristic or information as defined by the service provider or the digital device user. Additionally, the stored program listing may be presented in ascending or descending order based on the chosen listing characteristic. Additionally, programs on the stored program listing may be presented in a preferred order or in priority order by user bookmarks, ranking, preferences or the like.

Subsequent left scrolling or key activation will result in the next time plane being displayed. In the illustrated embodiment, scrolling or key activation from the stored today view 300 will result in the display of a stored yesterday view 310. The stored yesterday view provides for a vertical listing of all programs 302 and corresponding channel 304 that were stored yesterday. Alternatively, the stored yesterday view may provide for a vertical listing of stored programming by channel order.

Next in past time hierarchical order, subsequent left scrolling or key activation will result in display of the next past time plane. In the illustrated embodiment, left scrolling or key activation from the stored yesterday view 310 will result in the display of the stored week view 320. The stored week view provides for a vertical listing of the programs 302, and corresponding channel 304, stored for the current week. Alternatively, the stored week view may provide for a vertical listing of the days in the week. In such an embodiment, highlighting and/or activating a date within the listing of the week view will provide for the presentation of the stored date view for the chosen date. The stored date view will resemble the stored today view 300, in that it will provide for the listing of all programs stored on the chosen date. Alternatively, the stored week view may provide for a vertical listing of stored programming by channel order.

From the stored week view 320, subsequent scrolling or key activation will result in the display of the next time plane, such as a stored month view 330 and/or a stored year view 340. The month view may be configured to provide for a vertical listing of all programs stored during the month (as shown) or the vertical listing may provide a list of the weeks in the current month, all the dates in the month or any other time period. The stored year view may be configured to provide for a vertical listing of all programs stored in the year (a shown) or the vertical listing of the months of the year, the weeks of the year, the days of the year or any other time period. Alternatively, the stored month and year views may provide for a vertical listing of stored programming by channel order.

FIG. 5 provides for ESG views that highlight the view that is displayed when a user chooses an entry in a listing, in accordance with an embodiment of the present invention. For example, FIG. 5 shows the current time view 200 and the next time view 210. A user may highlight and/or activate a listing in the current time view to change from the ESG application to the current program. Highlighting and/or activating a listing in the next time view or any view that lists future programming, may result in the display of a program view 400. The program view provides for a vertically scrollable listing of user options related to the program. Highlighting and/or activating the user options will provide for the either the display of additional information related to the option or will activate the occurrence of the chosen option. For example, the user-options may be “record” 402, “remind” 404, “send” 406, and “more information” 408. The “record” option provides for the program to be recorded and stored for future access. The “remind” option provides for the user to be sent a reminder, typically in the form of a visual or audible alarm, that the program is due to be broadcast in the near future. The “send” option provides for the program to be sent to another digital device upon broadcast. The “more information” option provides the user with more detailed information pertaining to the program. The list of options shown in the program view are by way of example only, as such, other options may be presented in the program view without departing from the inventive concepts herein disclosed.

FIG. 5 also illustrates the current date view 220 and the current week view 230. A user may highlight and/activate a date listing in the current week view, such as the listing “Wednesday 13/05”, to display the date view 410 for the chosen date. The date view will resemble the current date view, in that, it will provide for a listing of all programs 412 shown on the specified date and a listing of the channels 414 corresponding to the programs. Highlighting and/or activating a listing in the date view 410 view, may result in the display of the program view 400.

Additionally, from a lower level view, such as program view 400 or the date view 410 the application can return to the corresponding higher level view, such as next time view 210 or current week view 230 by an appropriate keystroke, such as double clicking the up arrow key or by scrolling to the heading of the lower level view and activating.

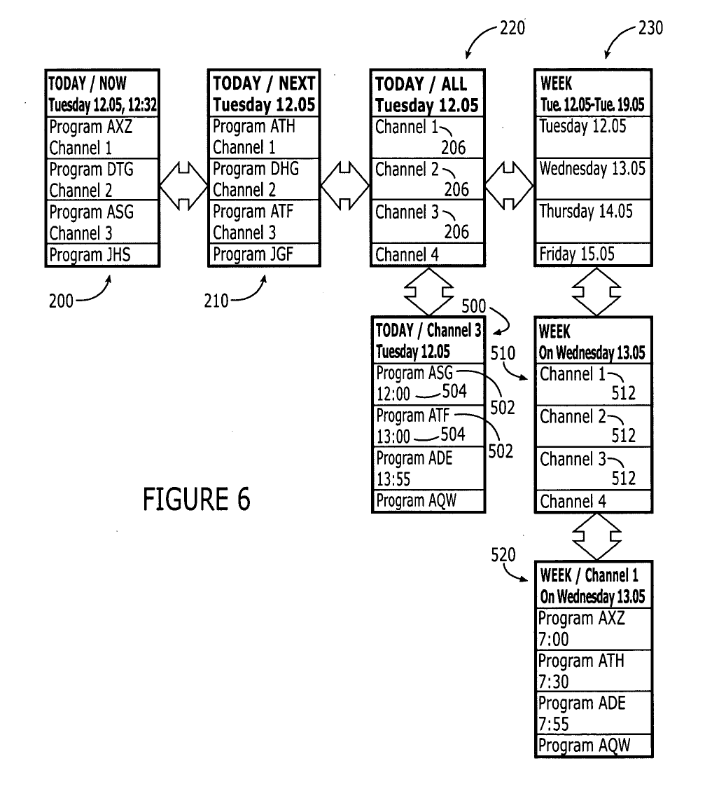

FIG. 6 provides an example of further hierarchical listing of channels and programs, according to an alternate embodiment of the present invention. Shown is the transition from current time view 200 to the next time view 210, the current date view 220 and the current week view 230. However, in the illustrated embodiment the current date view is limited to a vertical listing of the available program channels 206 (as opposed to a listing of the programs, as shown in FIG. 3). Highlighting and/or activation of one of the channels within the current date listing provides for the display of current date channel view 500. The current date channel view provides a listing, typically in time of program order, of all the program titles 502, and the starting time 504 of the program available on the selected channel for the selected date. Highlighting and/or activating a listing within the current date channel view may provide for the presentation of the program view 400 (shown in FIG. 5).

In similar fashion, highlighting and/or activation of date within the current week view 230 will provide for the display of a week channel view 510. The week channel view provides the user with a listing of the available channels 512. Highlighting and/or activation of one of the channels within the week channel listing provides for the display of a selected date channel view 520. The selected date channel view will resemble the current date channel view 500, in that, the selected date channel view will provide a listing, typically in time of program order, of all the programs available on the selected channel for the selected date.

Additionally, from a lower level view the application can return to the corresponding higher level view by an appropriate keystroke, such as double clicking the up arrow key or by scrolling to the heading of the lower level view and activating. For example, in FIG. 6, the application can return from date channel view 500 to the current date view 220 or the selected date channel view 520 can return to the week channel view 510 (and subsequently to the current week view 230) by keystroke or activation of the lower level view heading.

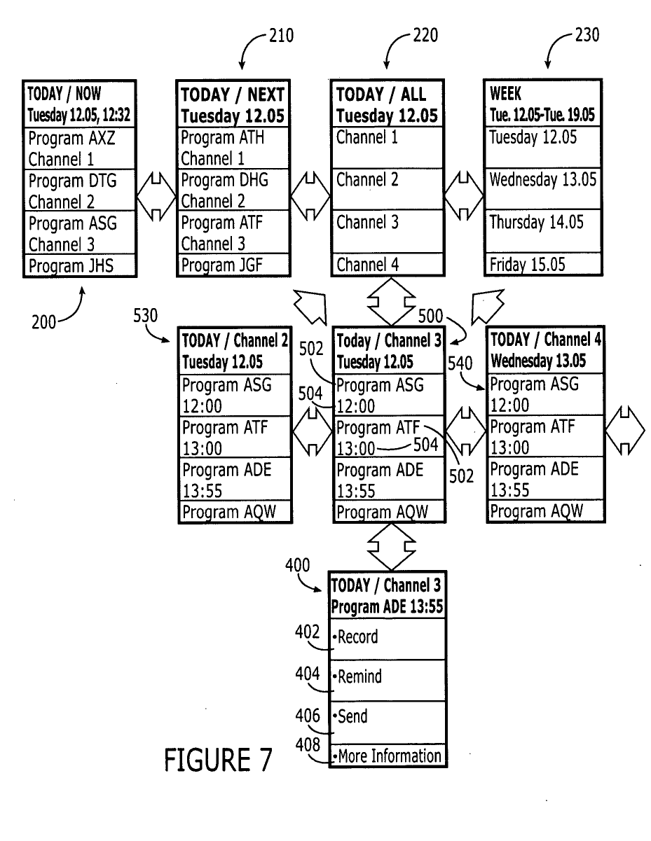

FIG. 7 provides an example of further hierarchical listing of channels and programs and the ability of the application to maneuver about various views, according to an alternate embodiment of the present invention. Shown is the transition from current time view 200 to the next time view 210, the current date view 220 and the current week view 230. A user may select a listing from the current date view, such as “Channel 3” and the ESG application may present the user with a second level in the time plane, the current date channel view 500. The current date channel view provides a listing of all programs, and the corresponding start time, shown on the specified channel on the specified date. A user may select a listing from within the current date view channel view, such as “Program ADE, 13:55” and the ESG application may present the user a third level in the time plane, a program view 400. The program view provides the user with various options related to the selected program, such as record option 402, remind option 404, send option 406 or more information option 408.

The user of the ESG application may also be provided with the option of moving to other current date channel views from the displayed current date channel view. For example, in the FIG. 7 embodiment, a user having displayed the current channel view 500 related to Channel 3 may move to an adjacent current channel view 530 or 540, such as Channel 2 or Channel 4, and the view 530 and 540 may present the same time frame as the view 500. Typically, such movement from the current channel view to an adjacent current channel view is accomplished by a scrolling function or key activation, such as horizontal scrolling of a joystick or left and right arrow key activation. From the adjacent current channel view a user may continue to move to a desired current channel view by further scrolling. Additionally, from any of the current channel views the ESG application may be configured such that a keystroke function, such as a double click of the up arrow key, results in the application returning to the current date view 220. Likewise, the application may be configured such that returning from any lower level view, such as a program view, to a higher level view, such as the views shown in FIGS. 3 and 4, can be accomplished by a keystroke function, such as a double click of the up arrow key.

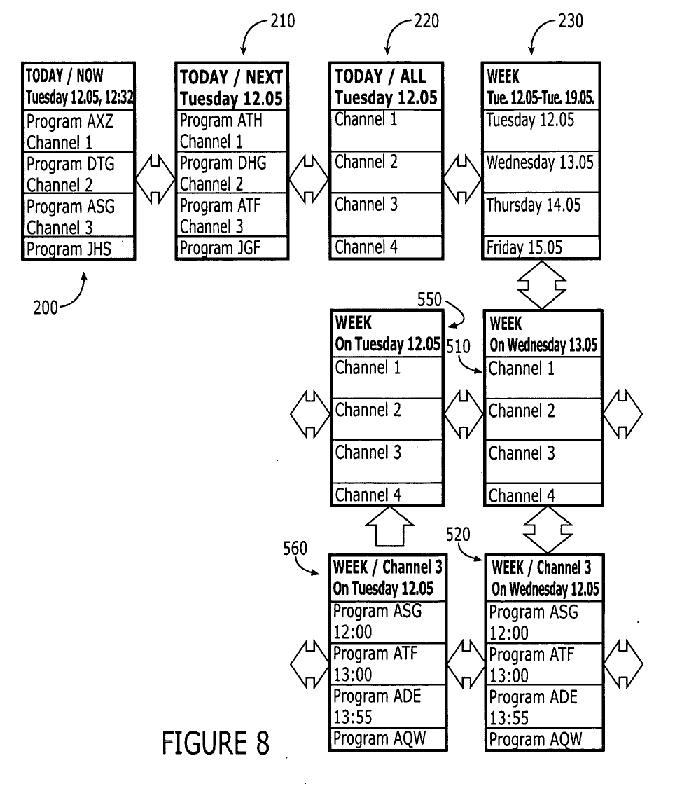

FIG. 8 provides a further example of hierarchical listing of channels and programs and the ability of the application to maneuver about various views, according to an alternate embodiment of the present invention. Shown is the transition from current time view 200 to the next time view 210, the current date view 220 and the current week view 230. A user may select a listing from the current week view, such as “Wednesday 13.05” and the ESG application may present the user with a second level in the time plane, the week channel view 510. The week channel view provides a listing of all channels available on the selected date. A user may select a listing from within the current date view channel view, such as “Channel 3” and the ESG application may present the user a third level in the time plane, a selected date channel view 520. The selected date channel view will provide a listing, typically in time of program order, of all the programs available on the selected channel for the selected date.

Similar to the example shown in FIG. 7, the user of the ESG may also be provided with the option of moving to other week channel views and selected date channel views from the displayed week channel view and selected date channel. For example, in the FIG. 8 embodiment, a user having displayed the week channel view 510, related to Wednesday 13.05, may move to and from an adjacent week channel view 550, such as Tuesday 12.05. Similarly, a user having displayed the selected date channel view 520, related to Channel 3 on Wednesday 13.05, may move to and from an adjacent date channel view 560, such as Channel 3 on Tuesday 13.05 on the same time frame. Likewise, a user may move to the date channel view 560 by selection and activation of a listing in the adjacent week channel view 550. For example, selection and activation of the “Channel 3” listing from the adjacent week channel view 550 will provide the display of date channel view 560.

Additionally, as previously noted the application may be configured to provide for a return from a lower level view, such adjacent week channel view 550 or selected date channel view 520 to a higher level view, such as adjacent week channel view 550 or week channel view 510, by activation of the heading or by appropriate keystroke.

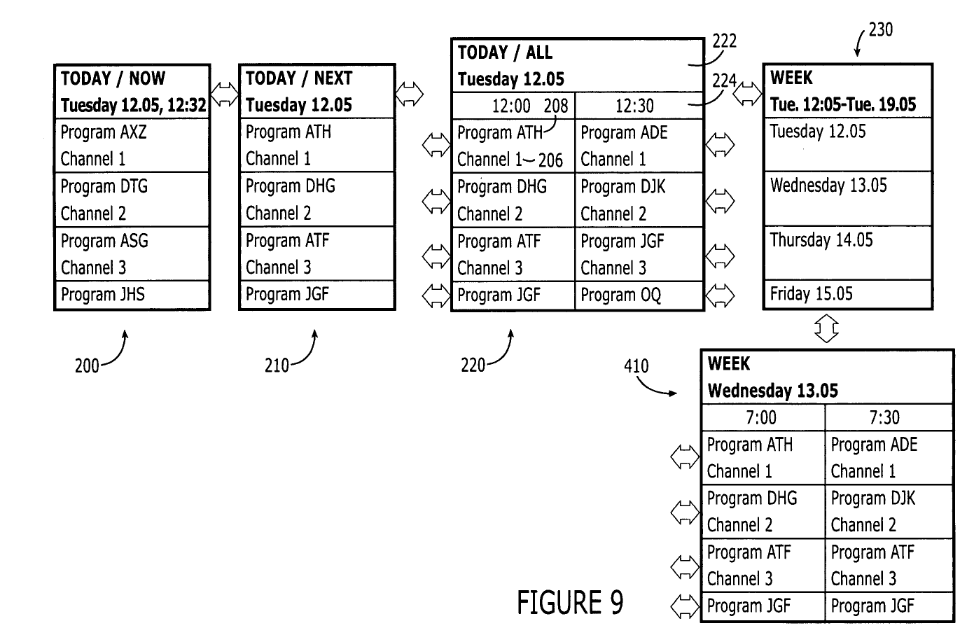

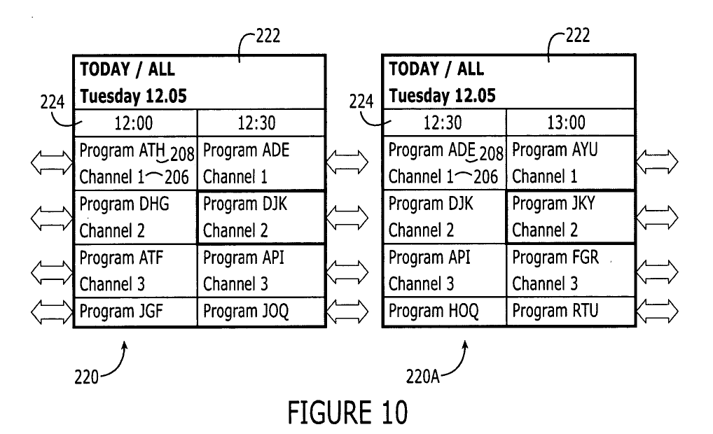

FIGS. 9 and 10 provide for alternate approaches to listing programs and channels within ESG views in accordance with an embodiment of the present invention. Shown in FIG. 9 is the transition from current time view 200 to the next time view 210, the current date view 220 and the current week view 230. The current date view differs from preceding current date views in that the listing is not limited to being vertically scrollable, but rather is in matrix format that is scrollable both vertically and horizontally. The current date view includes a heading portion 222. Horizontal scrolling, typically by joystick movement or right arrow key activation, from within the heading portion of the current date view will provide for the ESG application to move to the next time plane. For example, right scrolling will move to the week time plane, i.e., the current week view 230 and left scrolling will move to the today/next plane, i.e., the next time view 210.

A user may highlight and/activate a date listing in the current week view 230, such as the listing “Wednesday 13/05”, to display the date view 410 for the chosen date. The date view may resemble the current date view 220 FIG. 9, in that, it will provide for a matrix format that is scrollable both vertically and horizontally. Highlighting and/or activating a listing in the date view 410, may result in the display of the program view 400 (not shown in FIG. 9).

The current date view of the FIGS. 9 and 10 embodiments also include a time heading 224. The time heading lists time periods in the horizontal axis. Listed in the vertical axis under each time period are the programs 208, and corresponding channels 206, scheduled for that particular time period. Horizontal scrolling from within either the time heading or the listing of programs will provide for the application to move to the next time period. See for example FIG. 10, in which the cursor has highlighted the program listing “Program DJK, Channel 2”. Horizontal scrolling to the right provides for the display of an adjacent current date view 220A that includes the next-in-time time period, 13:00. Further horizontal scrolling to the right provides for the display of additional views include subsequent time periods. Conversely, horizontal scrolling to the left provides for the display of views that include prior-in-time time periods.

Thus, the present invention provides for an Electronic Service Guide (ESG) computer program, devices and systems that implement the ESG graphical user interface application and methods for providing service guide information to portable device users. The ESG application of the present invention is formatted so as to be adaptable to portable digital devices, typically handheld device that have small displays. The ESG application of the present invention provides service program schedules in a hierarchical format, as such, the user benefits from a guide that is highly user-friendly in the small display environment. In this regard, the user is able to readily locate and access program schedules, program options and program information through minimal user-interface with the device. Additionally, the present invention may provide for a guide that provides recording functionality and ease in locating programs that have been stored by the digital device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An application for providing access to service information on a display of a digital device, the application comprising a computer readable storage medium having computer-readable program instructions embodied in the medium, the computer-readable program instructions comprising:
first instructions for generating a current service information view that provides access to service information currently being delivered; and
second instructions for generating one or more future service information views that provide access to service information of future service delivery and wherein each of the one or more future service information views are defined by hierarchical time planes,
wherein a user of the application implements digital device user-interfaces to change from display of the current service information to one of a chosen future service information views.

2. The application of claim 1, wherein the first instructions for generating a current service information view further provides for the current service information view to include a vertically scrollable listing of program title and corresponding channel.

3. The application of claim 1, wherein the second instructions for generating one or more future service information views further provides for the one or more future service information views to be defined by hierarchical time planes chosen from the group consisting of next time period, next hour, current day, current week, current month and current year.

4. The application of claim 1, wherein a user of the application implements digital device user-interfaces, in the form of horizontal scrolling, to change from display of the current service information to one of a chosen future service information views.

5. The application of Clam 1, wherein the second instructions for generating one or more future service information views that are defined by hierarchical time planes further provide for generating multiple level views within the hierarchical time planes of the one or more of the future service information views.

6. The application of claim 5, wherein a user of the application implements digital device user-interfaces, in the form of vertical scrolling, to move from levels of view within the hierarchical time planes of the one or more of the future service information views.

7. The application of claim 5, wherein the second instructions for generating multiple level views within the hierarchical time plane of the one or more of the future service information views further provide for generating a program option level as one of the multiple level views.

8. The application of claim 7, wherein the second instructions for generating a program option level further define the program option level as including options chosen from the group consisting of recording the program, reminding the device user of the future service delivery, communicating the program or providing additional information related to the program.

9. The application of claim 1, wherein the second instructions for generating one or more future service information views further provide for the future service information views to include a vertically scrollable listing of program title and corresponding channel.

10. The application of claim 1, wherein the second instructions for generating one or more future service information views further provide for the future service information views to include a vertically scrollable listing of time periods.

11. The application of claim 1, wherein the second instructions for generating one or more future service information views further provide for the future service information views to include a vertically scrollable listing of program title and corresponding channel and a horizontally scrollable listing of time periods.

12. The application of claim 1, wherein the second instructions for generating one or more future service information views further provide for the future service information views to include a horizontally scrollable listing of program title and a vertically scrollable listing of time periods.

13. The application of claim 1, further comprising third instructions for generating one or more past service information views that provide access to service programs that have been stored by the digital device and wherein each of the one or more past service information views are defined by hierarchical time planes.

14. The application of claim 13, wherein the third instructions for generating one or more past service information views further provide for the one or more past service information views to be defined by hierarchical time planes chosen from the group consisting of current day, prior day, current week, current month and current year.

15. The application of claim 13, wherein the third instructions for generating one or more past service information views that are defined by hierarchical time planes further provide for generating multiple level views within the hierarchical time planes of one or more of the future service information views.

16. The application of claim 13, wherein the third instructions for generating one or more past service information views further provide for the past service information views to include a vertically scrollable listing of stored program title.

17. A digital device, the device comprising:
a processing unit;
a memory unit in communication with the processing unit that stores a service information application in the form of computer-readable program instructions including,
first instructions for generating a current service information view that provides access to service information currently being delivered; and
second instructions for generating one or more future service information views that provide access to service information of future service delivery and wherein each of the one or more future service information views are defined by hierarchical time planes; and
a display that displays the service information view and the one or more future service information views upon execution of the service information application by the processing unit.

18. The device of claim 16, further comprising one or more user-interfaces for controlling a view of the service information application presented on the display.

19. The device of claim 17, wherein the digital device is further defined as being chosen from the group consisting of a mobile communication device, a Personal Data Assistant (PDA), a portable audio device, a portable television device and a portable video device.

20. The device of claim 18, wherein the one or more user-interfaces are further defined ass being chosen from the group consisting of keyboard entry keys, joystick, arrow keys, touch screen and mouse.

21. The device of claim 17, wherein the memory unit that stores a service information application in the form of computer-readable program instructions including first instructions for generating a current service information view further defines the current service information as including a vertically scrollable listing of program title and corresponding channel.

22. The device of claim 17, wherein the memory unit that stores a service information application in the form of computer-readable program instructions including second instructions for generating one or more future service information views further provides for the one or more future service information views to be defined by hierarchical time planes chosen from the group consisting of next time period, next hour, current day, current week, current month and current year.

23. The device of claim 18, wherein the one or more user-interfaces provide for horizontal scrolling to move from the current service information view of the service information application to one or more of the future service information views.

24. The device of claim 17, wherein the memory unit that stores a service information application in the form of computer-readable program instructions including second instructions for generating one or more future service information views that are defined by hierarchical time planes further provide for generating multiple level views within the hierarchical time planes of the one or more of the future service information views.

25. The device of claim 18, wherein the one or more user-interfaces provide for vertical scrolling to move from levels of view within the hierarchical time planes of the one or more of the future service information views.

26. The device of claim 24, wherein the memory unit that stores a service information application in the form of computer-readable program instructions including second instructions for generating multiple level views within the hierarchical time planes further define one of the multiple level views as a program option level view.

27. The device of claim 26, wherein memory unit that stores a service information application in the form of computer-readable program instructions including second instructions for generating a program option level view further defines the program options as chosen from the list consisting of recording the program, reminding the device user of the broadcast, communicating the program or providing additional information related to the program.

28. The device of claim 17, wherein memory unit that stores a service information application in the form of computer-readable program instructions further includes third instructions for generating one or more past service information views that provide access to service programs that have been stored by the digital device and wherein each of the one or more past service information views are defined by hierarchical time planes.

29. The device of claim 28, wherein memory unit that stores a service information application in the form of computer-readable program instructions including third instructions for generating one or more past service information views further provide for the one or more past service information views to be defined by hierarchical time planes chosen from the group consisting of current day, prior day, current week, current month and current year.

30. The device of claim 26, wherein memory unit that stores a service information application in the form of computer-readable program instructions including third instructions for generating one or more past service information views that are defined by hierarchical time planes further provide for generating multiple level views within the hierarchical time planes of one or more of the future service information views.

31. A method for accessing future service information on a digital device, the method comprising the steps of:
providing a current service information view on a display of the digital device;
activating a user interface to change the view to a future service information view including a listing of future services;
selecting a future service from the future service information view; and
displaying a service option view that provides a user options related to the future service.

32. The method of claim 31, wherein the current service information view and the future service information view are further defined by hierarchical time planes.

33. The method of claim 31, wherein the step of providing a current service information view on a display of the digital device further provides for providing a current service information view on a display of the digital device, wherein the digital device is chosen from the group consisting of a mobile communication device, a Personal Data Assistant (PDA), a portable audio device, a portable television and a portable video device.

34. The method of claim 31, wherein the step of providing a current service information view on a display of the digital device further comprises providing a current service information view that includes a vertically scrollable listing of current programs.

35. The method of claim 31, wherein the step of activating a user interface to change the view to a future service information view including a listing of future service information further comprises horizontally scrolling a user interface to change the view to a future service information view.

36. The method of claim 31, wherein the step of activating a user interface to change the view to a future service information view including a listing of future services further provides for activating a user interface to change the view to a future service information view including a vertically scrollable listing of future services.

37. The method of claim 31, wherein the step of activating a user interface to change the view to a future service information view including a listing of future services further provides for activating a user interface to change the view to a future service information view including a vertically and horizontally scrollable listing of future services.

38. The method of claim 31, wherein the step of displaying a service option view that provides a user options related to the future service further provides for displaying a service option view that provides one or more options related to the future service wherein one of the options includes a record option for recording the service.

39. The method of claim 38, further comprising the step of selecting the record option from the service option view to record the selected future service.

40. The method of claim 31, wherein the step of displaying a service option view that provides a user options related to the future service further provides for displaying a service option view that provides one or more options related to the future service wherein one of the options includes a reminder option for reminding a device user of the selected future service delivery.

41. The method of claim 40, further comprising the step of selecting the reminder option from the service option view to remind the device user of a future service delivery.

42. The method of claim 31, wherein the step of displaying a service option view that provides a user options related to the future service further provides for displaying a service option view that provides one or more options related to the future service wherein one of the options includes a send option to communicate the selected future service to a secondary digital device.

43. The method of claim 42, further comprising the step of selecting the send option from the service option view to send the selected future service to a secondary digital device.

44. A method for accessing stored service on a digital device, the method comprising the steps of:
providing a current service information view on a display of the digital device;
activating a user interface to change the view to a past service information view including a listing of stored services;
selecting a stored service from the future service information view; and
accessing the stored services.

45. The method of claim 44, wherein the step of providing a current service information view on a display of the digital device further provides for providing a current service information view on a display of the digital device, wherein the digital device is chosen from the group consisting of a mobile communication device, a Personal Data Assistant (PDA), a portable audio device, a portable television device and a portable video device.

46. The method of claim 44, wherein the step of providing a current service information view on a display of the digital device further comprises providing a current service information view that includes a vertically scrollable listing of current programs.

47. The method of claim 44, wherein the step of activating a user interface to change the view to a past service information view including a listing of stored services further comprises horizontally scrolling a user interface to change the view to a past service information view.

48. The method of claim 44, wherein the step of activating a user interface to change the view to a past service information view including a listing of past services further provides for activating a user interface to change the view to a past service information view including a vertically scrollable listing of stored services.

49. The method of claim 44, wherein the step of activating a user interface to change the view to a past service information view including a listing of stored services further provides for activating a user interface to change the view to a past service information view including a vertically and horizontally scrollable listing of past services.

50. The method of claim 44, wherein the current service information view and the past service information view are defined by hierarchical time planes.

51. A graphical user interface that provides for access to service information on the display of a digital device, the graphical user interface being generated by computer-readable program instructions stored in a computer readable storage medium, the computer-readable program instructions comprising:
first instructions for generating a first view that includes a future time plane and a plurality of user-selectable media objects, wherein each of the selectable media objects correspond to information related to a future service; and
second instructions for generating a second view that includes a past time plane and a plurality of user-selectable media objects, wherein each of the selectable media objects correspond to information related to a previously stored service.
wherein user input to the digital device directs the user interface to change from the first view to the second view.

52. The graphical user interface of claim 51, wherein the first instructions for generating a first view that includes a future time plane and a plurality of user-selectable media objects further provides for the user-selectable media objects to be vertically scrollable and include a future program title and corresponding program channel.

53. The graphical user interface of claim 51, wherein the user input to the digital device that directs the user interface to change from the first view to the second view is further defined as horizontal scrolling from the first view to the second view.

54. The graphical user interface of Clam 51, wherein the first instructions for generating a first view that includes a future time plane and a plurality of user-selectable media objects further provides for the selection of the user-selectable media objects to result in display of one or more sub-level views.

55. The graphical user interface of claim 51, wherein the second instructions for generating a second view that includes a past time plane and a plurality of user-selectable media objects further defines the selectable media objects as selectable to access a previously stored service.
